(19) United States
(12) Patent Application Publication
(10) Pub. No.: US 2026/0237375 A1
(43) Pub. Date: Aug. 13, 2026

(54) APPARATUS AND METHOD FOR REDUCING NOISE IN A SPACE DUE TO A NOISY SYSTEM BY ELECTRONIC NOISE CANCELLATION

(71) Applicant: Nuovo Pignone Tecnologie - S.r.l., Florence (IT)

(72) Inventors: Francesco AZZINI, Florence (IT); Francesco ROSSETTI, Florence (IT)

(21) Appl. No.: 19/153,177

(22) PCT Filed: Feb. 2, 2024
(86) PCT No.: PCT/EP2024/025062

§ 371 Date: Aug. 1, 2025

(30) Foreign Application Priority Data
Feb. 8, 2023 (IT) 102023000002073

(51) Int. Cl. G10K 11/178

(52) U.S. Cl. CPC G10K 11/17857; G10K 11/1781; G10K 11/17873; G10K 2210/12; G10K 2210/3025

(57) ABSTRACT

An innovative apparatus is configured to reduce noise generated by a noisy system in a space that is predetermined, limited and at a distance from the noisy system. The apparatus comprises: a microphone configured to receive noise from the noisy system and to generate noise electric signals, a loudspeaker configured to receive acoustic electric signals and consequently to emit acoustic waves toward said space, and a noise processor having an input coupled to the microphone and an output coupled to the loudspeaker. The noise processor is configured to generate the acoustic electric signals by processing the noise electric signals so that noise waves coming from the noisy system and the acoustic waves coming from the loudspeaker combine and cancel at said space.

### TECHNICAL FIELD

The subject matter disclosed herein relates to an apparatus and a method for reducing noise in a space by electronic noise cancellation.

### BACKGROUND ART

It is common experience that any machine generates noise while it operates. Noise is propagated around the machine through ambient air as noise waves. People located close to the machine are disturbed by the noise. The level of noise at any position in the surroundings of the machine depends on several factors including the power of the noise generated by the machine and the distance from the machine. In general, the bigger is the machine the higher is the noise generated.

In some fields of technology, such as e.g. Oil & Gas, machines or machines arrangements are sometimes enclosed inside a (sound) insulation enclosure, sometimes called “package”, in order to reduce noise spread in the surroundings. Alternatively or additionally, a (sound) insulation cabinet, for example a so-called “control room”, is provided in the surroundings of the machine where people may stay and work under reduced noise conditions.

In any case, even if an insulation enclosure and/or an insulation cabinet is used, noise outside the insulation enclosure or inside the insulation cabinet is often not negligible for a person being close to the machine. A person may be there as he needs to monitor and/or act on the machine (or on an apparatus connected or coupled to the machine) for example for maintenance purposes.

Therefore, HPDs (=“Hearing Protection Device”), such as e.g. Earmuffs and Earplugs, are known and used by operators. However, HPDs have several limitations; for example, they are not particularly comfortable especially if they need to be carried for a long time and they do not allow communication of the persons wearing them with other people.

Solutions for noise cancellation or reduction are known from e.g. US 2015/104026A1, US 2010/131269 A1 and U.S. Pat. No. 5,834,647 (corresponding to DE 69504204T2). None of these solutions are fully accurate and applicable to industrial applications, i.e. environments where there are a fixed-position noisy system and a fixed-position (limited-size) space to be silenced remote from each other and a silencer apparatus being configured to be position remotely from both the noisy system and space to be silenced.

It would be desirable to provide a solution for accurately reducing noise in a space for industrial applications.

### SUMMARY

According to a first aspect, the subject matter disclosed herein relates to an innovative system that allows to reduce noise generated by a noisy system and propagated through ambient air as noise waves; the noisy system comprises one or more noise sources; the apparatus is configured to reduce noise in a space being predetermined, limited and at a distance from the noisy system. The system comprises: at least one microphone, at least one loudspeaker and a noise processor. The microphone is configured to receive noise from the noisy system and to generate noise electric signals. The loudspeaker is configured to receive acoustic electric signals and consequently to emit acoustic waves toward the space. The noise processor has at least one input and at least one output; the input is electrically coupled to the microphone; the at output is electrically coupled to the loudspeaker. The noise processor is configured to generate the acoustic electric signals by processing the noise electric signals so that noise waves coming from the noisy system and the acoustic waves coming from the loudspeaker combine and cancel at the space. The loudspeaker is positioned at a fourth distance from the microphone, and the noise processor is configured so that a processing time of the noise electric signals is smaller than or equal to the fourth distance divided by a sound waves propagation speed in air and a delay time is provided in the apparatus; a sum of the processing time and the delay time is equal to the fourth distance divided by a sound waves propagation speed in air.

According to a second aspect, the subject matter disclosed herein relates to an innovative method for reducing noise generated by a noisy system and propagated through ambient air as noise waves; noise reduction is achieved through an apparatus in a space being predetermined, limited and at a distance from the noisy system. The method comprises the steps carried out by the apparatus of: generating acoustic waves, directing the generated acoustic waves toward the space, and regulating the generated acoustic waves so that so noise waves coming from the noisy system and the generated acoustic waves combine and cancel at the space. The regulating step provides introducing a delay time having a value related to the distance and related to positions of the noisy system, of the space, and of components of the apparatus.

According to a third aspect, the subject matter disclosed herein relates to an arrangement comprising a noisy system and an apparatus for reducing noise generated by the noisy system in a space predetermined, limited and at a distance from the noisy system; the apparatus is an innovative noise-rection apparatus and/or is configured to implement an innovative noise-reduction method.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic block diagram of a first embodiment of an innovative apparatus,

FIG. 2 shows the embodiment of FIG. 1 with some distances of interest,

FIG. 3 shows a schematic block diagram of a possible noisy system,

FIG. 4 show a schematic block diagram of two possible alternative spaces where noise reduction is aimed at,

FIG. 5 shows a schematic block diagram of a second embodiment of an innovative apparatus,

FIG. 6 shows a detailed block diagram of an embodiment of a noise processor that may be used for example in the embodiment of FIG. 1 or FIG. 5,

FIG. 7 shows of an embodiment of a loudspeaker arrangement that may be used for example in the embodiment of FIG. 1 or FIG. 5,

FIG. 8 shows a flowchart of an embodiment of an innovative method, and

FIG. 9 shows a flowchart of a possible implementation of a specific step in the innovative method of FIG. 8.

### DETAILED DESCRIPTION OF EMBODIMENTS

According to the subject matter disclosed herein, noise reduction is achieved in a predetermined and limited space, e.g. a space where persons are most likely to be during operation of the noisy system, not the whole surroundings. The space could be a completely closed in space, for example, a room having a defined area and volume, or a partially closed space having one or more variances where the area and volume are not completely defined. Considering such assumption, noise reduction through electronic means may be carried out in an effective way; the theoretical aim is to reduce noise completely. An innovative electronic apparatus emits acoustic waves that cancel, at least partially, with noise waves from the noisy system at such space. Out of such space, noise cancellation is quite poor or even absent.

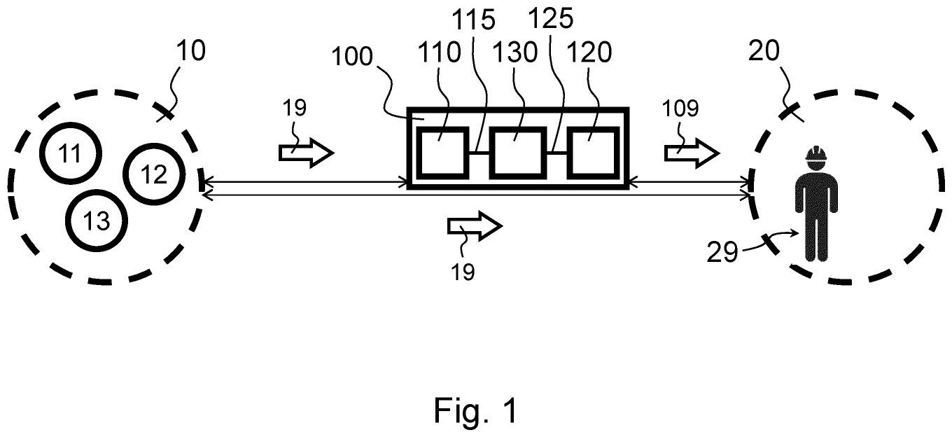

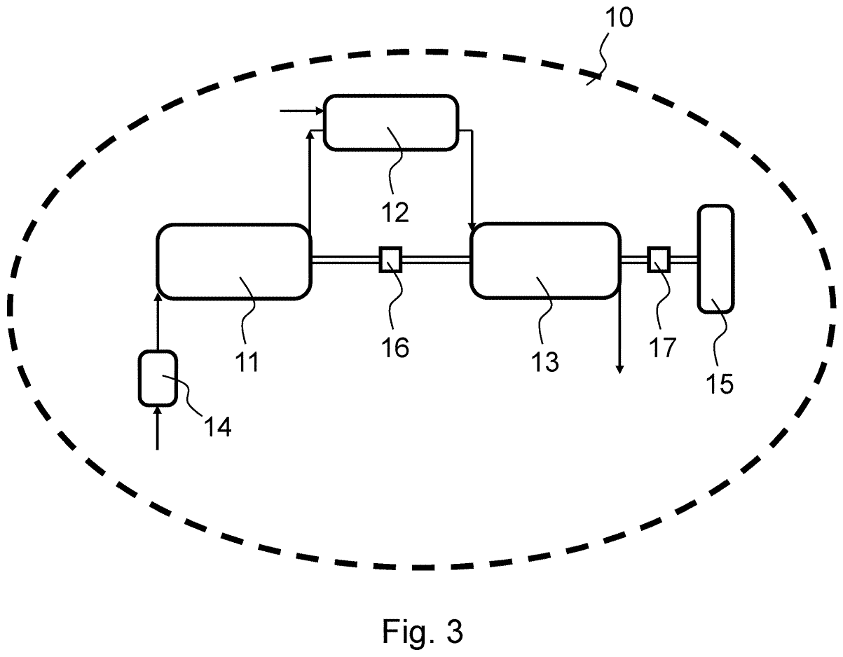

In FIG. 1, an exemplary noisy system 10 is schematically shown. According to this example, the system 10 includes three distinct noise sources 11, 12, and 13. Better understanding regarding the noisy system may be derived from FIG. 3 as explained later.

In FIG. 1, an exemplary noisy system 10 is schematically shown. According to this example, the system 10 includes three distinct noise sources 11, 12, and 13. The system 10, in particular its sources 11 and 12 and 13, generates noise that is propagated through ambient air as noise waves 19; it is to be noted that noise waves propagate all around the system 10 in any direction and the arrow 19 is oriented according to a specific direction as this is the propagation direction involving an exemplary innovative apparatus 100 shown in FIG. 1 and an exemplary space 20 shown in FIG. 1. In FIG. 1, arrow 19 represents propagating noise waves resulting from the combination of noise generated from all noise sources of the system 10. As distance from the system 10 increases, the specific origins of noise (i.e. sources 11, 12 and 13) cannot be distinguished and the noisy system 10 can be equated to a single point source of noise. Furthermore, if a small-area surface (for example perpendicular to the propagation direction of the noise waves) is considered compared with the distance from the noisy system, the noise waves reaching this surface can be considered plane waves.

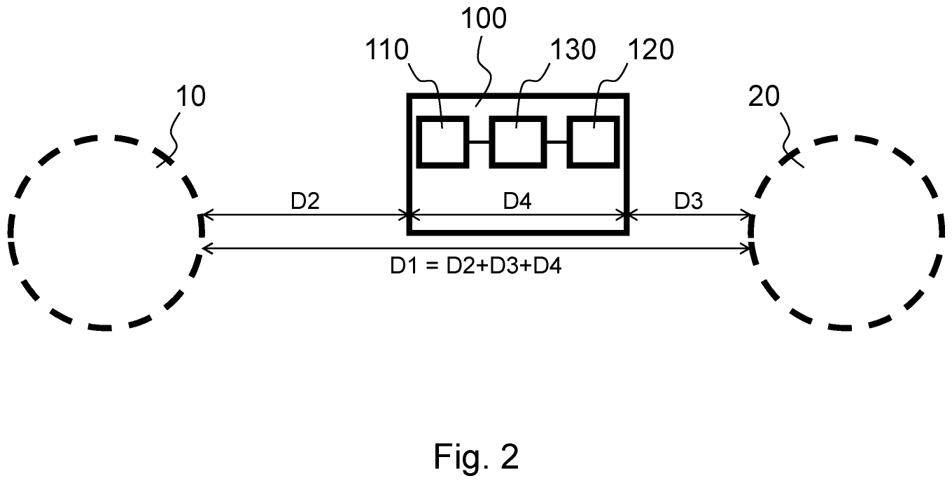

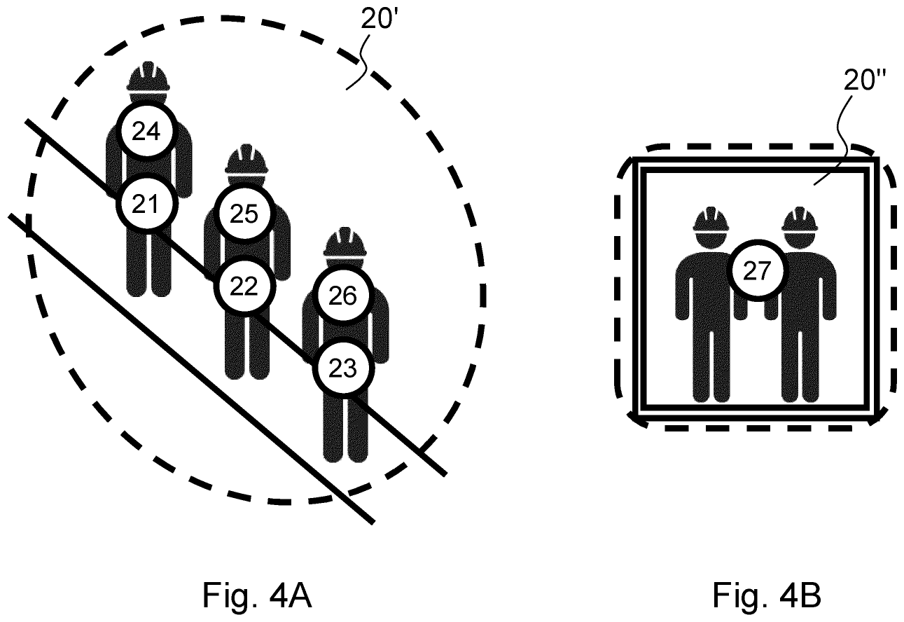

In FIG. 1, an exemplary “silenced” (i.e. where noise is reduced) space 20 is schematically shown that is limited and predetermined. According to this example, a person 29 is present inside the space 20. Better understanding regarding the “silenced” (i.e. where noise is reduced) space may be derived from FIG. 4A and FIG. 4B as explained later. In the example of FIG. 1, the space 20 is at a distance, in particular at a first distance D1 (as shown in FIG. 2), from the noisy system 10. It is to be noted that, in general, the space 20 is not to be considered an area of a ground surface, but it is a tridimensional limited volume (at any distance from ground) that need to be silenced.

The embodiment of innovative apparatus 100 in FIG. 1 is able to reduce noise generated by the noisy system 10 in the space 20. The apparatus 100 comprises:
a) at least one microphone 110 configured to receive noise, in particular noise waves 19, from the noisy system 10 and to generate noise electric signals 115, the at least one microphone 110 being configured to be positioned at a second distance D2 (see FIG. 2) from the noisy system 10,
b) at least one loudspeaker 120 configured to receive acoustic electric signals 125 and consequently to emit acoustic waves 109 toward the space 20, the at least one loudspeaker 120 being configured to be positioned at a third distance D3 (see FIG. 2) from the space 20, and
c) a noise processor 130 having at least one input and at least one output, wherein the at least one input is electrically coupled to the at least one microphone 110, wherein the at least one output is electrically coupled to the at least one loudspeaker 120;

The noise processor 130 is an electronic processor and is configured to generate the acoustic electric signals 125 by processing the noise electric signals 115 so that noise waves 19 coming from the noisy system 10 and the acoustic waves 109 coming from the at least one loudspeaker 120 combine and cancel, at least partially, at the space 20. In practice, cancellation cannot be perfect; it may vary slightly from point to point inside the space; it may depend on the size of the space; in any case, noise reduction can be achieved inside the whole space.

As the space 20 to be “silenced” is limited, the overall power of the acoustic waves 109 emitted by the apparatus 100 is much smaller than the overall power of the noise waves emitted by the noisy system 10.

It is advantageous to choose the second distance D2 (see FIG. 2) greater than the third distance D3 (see FIG. 2); in other words, to place the innovative apparatus 100 relatively close to the space 20 to be “silenced”, more specifically closer to the space 20 than to the system 10. In this way, the overall power of the acoustic waves 109 emitted by the apparatus 100 can be relatively small; as the amplitude of the a propagating acoustic wave is a function of the inverse square of the distance. It is to be noted that the third distance D3 is not negligible, such as for example few centimeters (or millimeters).

As already explained, it is advantageous to choose first distance D1 (see FIG. 2) is greater than a first predetermined value, for example 15 m or 30 m; in other words, to place the space 20 to be “silenced” quite far away from the noisy system 10. One reason is that, in this way, the noise waves 19 reaching the space 20 may be considered plane waves.

It is advantageous to choose second distance D2 (see FIG. 2) is greater than a second predetermined value, for example 10 m or 20 m; in other words, to place the innovative apparatus 100 quite far away from the noisy system 10. One reason is that, in this way, the noise waves 19 reaching the apparatus 100 may be considered plane waves.

It is advantageous to choose third distance D3 (see FIG. 2) is greater than a third predetermined value, for example 5 m or 10 m, but at least 1 m; in other words, to place the innovative apparatus 100 quite far away from the space 20. One reason is that, in this way, the acoustic waves 109 reaching the space 20 may be considered plane waves. Typically, the third distance D3 is in the range between ½ and 1/10 of the first distance D1.

The innovative apparatus may comprise a plurality of microphones (which is not shown in any of the figures). This may be advantageous in order to capture noise of different frequencies (in this case, the microphones are different) and/or in order better capture all the noise emitted by the noisy system for example by appropriately positioning the microphones (in this case, the microphones may be identical).

The innovative apparatus may comprise a plurality of loudspeakers. FIG. 7 shows a loudspeaker arrangement made of a first loudspeaker 121, a second loudspeaker 122 and a third loudspeaker 123, all of them being electrically coupled to the noise processor 130. The loudspeakers of the plurality may be used for example to cover a larger space to be “silenced”. Using a plurality of loudspeakers, preferably arranged as a horizontal array or a vertical array (as shown in FIG. 7), may allow to control (typically to fine tune for example during a preliminary adjustment) the wave group propagation direction of the emitted acoustic waves by regulating the relative phase of the different acoustic electric signals supplied to the distinct loudspeakers.

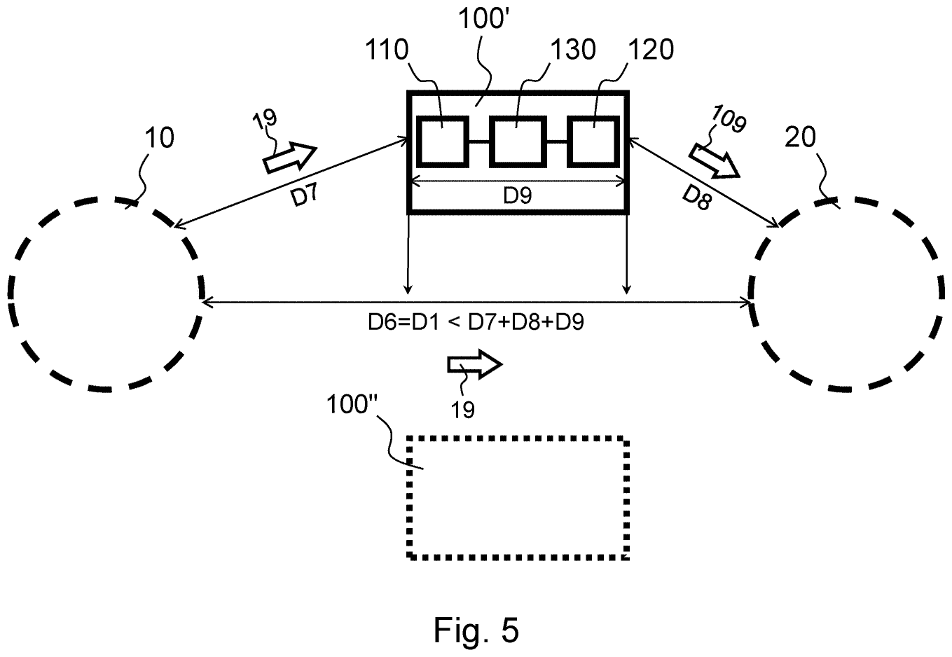

Considering the embodiment of FIG. 1, the loudspeaker 120 is positioned at a fourth distance D4 (see FIG. 4) from the microphone 110. The whole apparatus 100 may include a casing, having for example the shape of a tube, containing all its components, the loudspeaker(s) being at a first end of the casing and the microphone(s) being at a second (opposite) end of the casing. Such features may also be present in the embodiment of FIG. 5; indeed, the apparatus 100 of FIG. 1 and the apparatuses 100′ and 100″ of FIG. 5 are very similar.

Considering specifically the particularly advantageous embodiment of FIG. 1, the noisy system 10, the space 20 and the apparatus 100 may be considered aligned or “in line”. In this case, the first distance D1 is equal to the sum of the second distance D2, the third distance D3, the third distance D3. The fourth distance D4 divided by a sound waves propagation speed in air is advantageously greater than (or equal to) a processing time of the noise electric signals 115 by the noise processor 130. In other words, the electronic processing time by the apparatus is smaller than (or equal to) the waves propagation time along the apparatus. More precisely and advantageously, the noise processor 130 may be configured so that a processing time of the noise electric signals 115 is smaller than or equal to the fourth distance D4 divided by a sound waves propagation speed in air and a delay time is provided in the apparatus 100 so that a sum of the processing time and the delay time is equal to the fourth distance D4 divided by a sound waves propagation speed in air; in this way, acoustic waves from apparatus 100 and acoustic waves from system 10 reach space 20 at the same time. In general, the delay time is regulated for optimal combination and optimal cancellation of noise at the space of interest considering the various parameters of the arrangement, including the frequency or frequencies and phase or phases of the noise from the noisy system.

Alternatively, considering specifically the embodiment of FIG. 5, the noisy system 10, the space 20 and the apparatus 100′ are not aligned. In this case, it is also desirable that apparatus 100′ is quick in processing the signals but it is necessary to consider all the distances, specifically with reference to FIG. 5, D6, D7, D8 and D9 (D6 may be equal for example to D1 but is smaller than the sum D7 and D8 and D9, and D9 may be equal di D4); for example, the waves propagation time along the distance D6 should be greater than the sum of the waves propagation time along distance D7, the waves propagation time along distance D8 and the processing time of the apparatus 100. As D6 should be smaller than D7+D8 (and also smaller than D7+D8+D9), it is be expected that the microphone(s) 110 should be positioned close to the noisy system 10 and/or the loudspeaker(s) 120 should be positioned close to the space 20. In general, optimal combination and optimal cancellation of noise at the space of interest is achieved by considering the various parameters of the arrangement, including the frequency or frequencies and phase or phases of the noise from the noisy system.

Considering specifically the embodiment of FIG. 5, it is advantageous to have two identical (or very similar) pieces of equipment 100′ e 100″ that may be considered two sections of a same innovative apparatus; each of these two sections 100′ and 100″ may be similar or identical to apparatus 100 in FIG. 1. These two sections are preferably positioned symmetrically with respect to the noisy system 10 and symmetrically with respect to the space 20 (see FIG. 5). In this way, cancellation of the noise may be much better (or even almost perfect).

In the light of the above considerations, FIG. 1 and FIG. 5 show the components of systems 100, 100′ and 100″ as close to each other; however, this is not to be construed as a limitation of the subject matter disclosed herein. In particular, the positions of the microphone(s) and/or loudspeaker(s) may be appropriately remote from the noise processor 130 and/or appropriately close to the system 10 and/or the space 20.

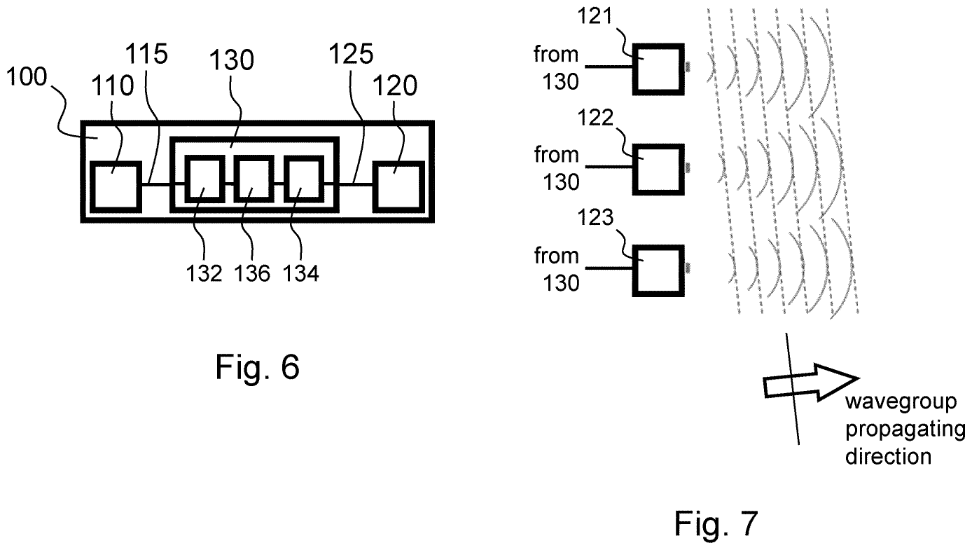

As already said, the innovative apparatus is an electronic apparatus as it processes electric signals. FIG. 6 shows a possible digital implementation of the apparatus 100 in FIG. 1 and FIG. 5. In particular, its noise processor 130 comprises an analog to digital converter 132 electrically coupled to the at least one microphone 110, a digital to analog converter 134 electrically coupled to the at least one loudspeaker 120, and an electronic processor 136, e.g. a microprocessor with associated program and data memory, electrically coupled between the analog to digital converter 132 and the digital to analog converter 134. It is to be noted that there are components called DSP (=“Digital Signal Processor”) that incorporates at least a processor, memory, a digital to analog converter and a analog to digital converter.

Considering FIG. 3, there is shown a system 300 corresponding to an exemplary noisy system 10 including several noise sources 11, 12, 13, 14, 15, 16 and 17. System comprises a compressor 310 corresponding to a first possible source 11 of noise, a combustor 320 corresponding to a second possible source 12 of noise, an expander 330 corresponding to a third possible source 13 of noise, an air filter 340 corresponding to a fourth possible source 14 of noise, an electric generator 350 corresponding to a fifth possible source 15 of noise, a first coupling 360 corresponding to a sixth possible source 16 of noise, a second coupling 370 corresponding to a seventh possible source 17 of noise. As it is evident from this figure, the various noise sources may be considered as concentrated in specific different positions. The noise coming from the various noise sources may be different from source to source in terms of spectral composition. According to the subject matter disclosed herein, noise can be in the range from 20 Hz to 20 KHz, corresponding to all the audible frequencies, or in a narrower range from e.g. 20 Hz to 5 KHz. In order to determine the operating range, it is to be noted that a turbomachine rotating at e.g. 12,000 RPM generates noise at a first fundamental frequency of 200 Hz and at its harmonic frequencies as well as for example at a second fundamental frequency of 200 Hz multiplied by the number of blades of any stage and at its harmonic frequencies.

Considering FIG. 4, FIG. 4A shows a first exemplary space 20′ to be silenced being an open space, i.e. not delimited by any element, and FIG. 4B shows a second exemplary space 20″ to be silenced being delimited by walls of e.g. a cabinet; in both cases, the space to be silenced may be e.g. 2-4 m (height) by 2-4 m (width) by 2-4 m (depth). In FIG. 4A, persons are shown inside the space 20′ at e.g. three places e.g. along a pathway; according to this example, a limited number of positions, for example six positions 21, 22, 23, 24, 25 and 26, are of particular interest; as will be better explained in the following, during preliminary adjustment and/or during preliminary training the noise reduction apparatus will be set so that noise is particular low (or even null) at these positions. In FIG. 4B, persons are shown inside the space 20″, in particular inside a closed cabinet; according to this example, a limited number of positions, for example only one position 27, are of particular interest; as will be better explained in the following, during preliminary adjustment and/or during preliminary training the noise reduction apparatus will be set so that during operation of the noisy system noise is particular low (or even null) at these positions.

In general, the innovative noise reduction method comprises the following steps (to be carried out by a silencer apparatus) from “b”, “c” and “d”, while “a” step a is typical but not strictly necessary and will be described later:
b) generating acoustic waves (see e.g. arrow 109 in FIG. 1 and FIG. 5),
c) directing the generated acoustic waves toward a space to be “silenced” (see e.g. circle 20 in FIG. 1 and FIG. 5), and
d) regulating the generated acoustic waves (see e.g. arrow 109 in FIG. 1 and FIG. 5) so that so noise waves (see e.g. arrow 19 in FIG. 1 and FIG. 5) coming from a noisy system (see e.g. circle 10 in FIG. 1 and FIG. 5) and the generated acoustic waves (see e.g. arrow 109 in FIG. 1 and FIG. 5) combine and cancel at the space to be “silenced” (see e.g. circle 20 in FIG. 1 and FIG. 5);
   as already explained, the space to be “silenced” is predetermined, limited and at a distance from the noisy system.

In the present case, both noise waves and acoustic waves are sound pressure waves that propagate through ambient air. As both waves reach the same limited space they interfere at this space. The innovative method aims at destructive interference at this space causing a low (ideally zero) local sound pressure wherever inside the space to be “silenced” (see e.g. FIG. 4).

When considering pressure waves propagating through a propagation means (in the present case ambient air) the following parameters should be taken into account: the distance from the emitting point (or more in general the positions of the silencer apparatus and its components), the amplitude (or power) at the emitting point, the phase at the emitting point, the frequency and the propagation speed in the propagation mean; this results in a 3D field that, under certain assumptions, may be considered a 2D field or even a 1D field (i.e. of a plane wave). According to the subject matter disclosed herein, we may consider, by simplification a superposition of two 3D fields, one due to the noisy system and one due to the innovative apparatus.

It is to be noted that although steps “b”, “c” and “d” are set out above as separate and sequential, when such method is implemented by an apparatus such steps occur practically at the same time and by the same devices. In particular and advantageously, regulation at step “d” is open-loop type at least during noise reduction operation. On the contrary, during adjustment (in particular preliminary adjustment) and/or during training (in particular preliminary training) regulation of the acoustic waves is typically closed-loop type, for example based on feedback signal or signals from the space to be “silenced”.

Typically, at step “b” timing of the generated acoustic waves is regulated. Typically, at step “b” amplitude of the generated acoustic waves is regulated. Typically, at step “b” phase of the generated acoustic waves is regulated. Advantageously, at step “b” timing, amplitude and phase of the generated acoustic waves are regulated.

Regulation at step “b” is carried out so achieve a very good (“optimal” so to say) cancellation of noise at the space.

The above mentioned step “a” (to be carried out by a silencer apparatus) includes receiving noise waves (see e.g. arrow 19 in FIG. 1 and FIG. 5) and is performed prior to step “b”. In this case, at step “b” the acoustic waves are generated based on the received noise waves, i.e. by processing the noise waves. More specifically, the timing and/or amplitude and/or phase of the generated acoustic waves depend on the timing and/or amplitude and/or phase of the received noise waves. In this case, the regulating at step “d” provides introducing a delay time having a value related to the distance and related to positions of the noisy system (e.g. 10), of the space (e.g. 20), and of noise waves receiving and acoustic waves generating components (e.g. 110, 120) of the silencer apparatus (e.g. 100). Considering FIG. 5, the positions of the noisy system 10 and the space 20 identify a first line segment (having a length equal to D6), the positions of the noisy system 10 and the noise waves receiving component 110 identify a second line segment (having a length equal to D7), the positions of the acoustic waves generating components 120 and the space 20 identify a third line segment (having a length equal to D8), the positions of the noise waves receiving component 110 and the acoustic waves generating components 120 identify a fourth line segment (having a length equal to D9); the delay time may be related to lengths of projections of the second line segment and of the third line segment on the first line segment and of the fourth line segment on the first line segment; the value of the delay time may be calculated based on the waves propagation times along these three projections so that the noise waves from the noisy system and the acoustic waves from innovative apparatus reach the space to be silenced at a same time and/or with a same phase shift and cancel.

According to some embodiments, the received noise waves are filtered into a plurality of bandwidths and for each bandwidth different acoustic waves are generated. This may allow for example to take into account that the propagation speed of a wave may depend on the wave frequency and/or that the sensitivity of human ears may depend on the sound frequency.

As already anticipated, in order to achieve a good noise reduction in the space, it is advantageous to perform a preliminary adjustment and/or a preliminary training and to generate the acoustic waves at step “b” based on such preliminary adjustment and/or a preliminary training. Preliminary adjustment of e.g. a noise reduction apparatus is performed after installation but before noise adjustment operation; to a certain extent, it may be performed when the noisy system is not operating; in general, it lasts for a short time (for example from some seconds to some minutes). Preliminary training of e.g. a noise reduction apparatus is performed after installation but before noise adjustment operation, and it is performed when the noisy system is not operating; in general, it lasts for a long time (for example tens of minutes or even hours). The aim of both the preliminary adjustment and the preliminary training includes setting processing parameters so to so that during operation of the noisy system noise is particular low (or even null) wherever inside the space to be “silenced” (see e.g. FIG. 4); to this aim, one or more specific positions inside this space may be considered in order to carry out e.g. an optimization algorithm.

FIG. 4B is quite peculiar in terms of noise. In fact, both noise waves and acoustic waves do not reach the persons in the space, i.e. inside the cabinet, directly. Noise waves and acoustic waves interfere, at least partially, at the walls of the cabinet (typically the wall(s) facing the noisy system and the noise reduction apparatus, in particular its loudspeaker(s)) and the acoustic pressure inside the cabinet may be partially dependent on the vibrations of such wall(s). In any case, the innovative method still applies.

The innovative method may be embodied in many different ways. For example, the silencer apparatus may be positioned in line with the noisy system and the space to be silenced, as shown e.g. in FIG. 1. Alternatively, for example, the silencer apparatus may be positioned not in line with the noisy system and the space to be silenced, as shown e.g. in FIG. 5; in particular, as also shown e.g. in FIG. 5, the silencer apparatus may be divided into first and second identical sections positioned symmetrically with respect to the noisy system and symmetrically with respect to the space to be silenced.

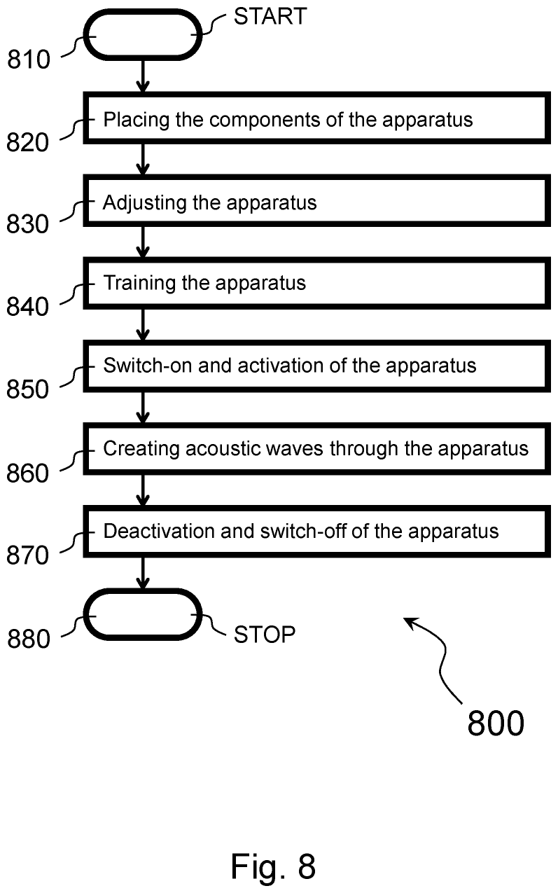

When the innovative method is embodied into apparatus for example the process 800 of the flowchart of FIG. 8 may occur. The process starts at block 810 and ends at block 880. At block 820, the components of an innovative apparatus (for example apparatus 100 of FIG. 1 or FIG. 5) are placed in particular with respect to a noisy system a space to be “silenced”; in particular, at least one microphone, at least one loudspeaker and a sound processor are placed. At block 830, the apparatus is adjusted as already explained for example before starting the noisy system. At block 840, the apparatus is trained as already explained for example after starting the noisy system but preferably without any person in the space to be “silenced”. Now the apparatus is ready to be used for silencing the space and, at block 850, the apparatus is first switched on and then activated (when the apparatus is active it ready to emit acoustic waves). At block 860, acoustic waves are actually created through the apparatus and directed to the space to be “silenced” so that such space is actually “silenced”, i.e. noise is reduced. At block 870, the apparatus is first deactivated and then switched off.

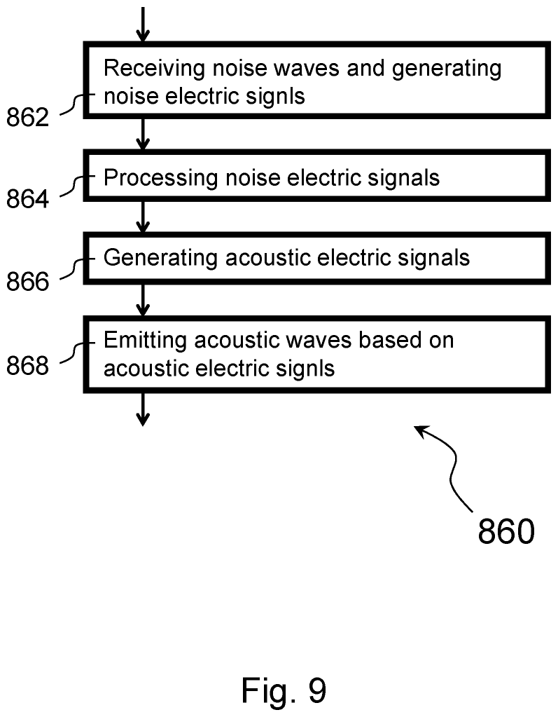

The flowchart of FIG. 9 explains more in detail possible activities that correspond to block 860. Initially, block 862 corresponds to receiving noise waves and generating noise electric signals. Afterwards, block 864 corresponds to processing noise signals. Afterwards, block 866 corresponds to generating acoustic electric signals. Finally, block 868 corresponds to emitting acoustic waves based on the acoustic signals.

It is to be noted that according to some embodiments an innovative apparatus may be activate only when necessary (i.e. not at any time when the noisy system is operating) for example only when persons are present or expected in the space; for example, it may be activated before arrival of the persons and deactivated after departure of the persons.

It is to be noted that according to some embodiments an innovative apparatus may be activated considering also the specific operating mode of the noisy system for example if the noisy system may have more than one operating mode; in other words, also the innovative apparatus may have more than one operating mode. Decision regarding the operating mode of the innovative apparatus may be taken for example at each activation. Decision regarding the operating mode of the innovative apparatus may come for example from control signals received from the innovative apparatus and/or from user commands received from the innovative apparatus.

It is to be noted that an innovative apparatus for reducing noise may be integrated into an arrangement together with at least a noisy system. The apparatus aims at reducing the noise generated by the noisy system in a space predetermined, limited and at a distance from the noisy system. In particular, the apparatus may be configured to implement the innovative noise reduction method.

1. An apparatus for reducing noise generated by a noisy system and propagated through ambient air as noise waves, wherein the noisy system comprises one or more noise sources, wherein the apparatus comprises:
a) at least one microphone configured to receive noise from the noisy system and to generate noise electric signals,
b) at least one loudspeaker configured to receive acoustic electric signals and consequently to emit acoustic waves toward said space, and
c) a noise processor having at least one input and at least one output, wherein the at least one input is electrically coupled to the at least one microphone, the at least one output being electrically coupled to the at least one loudspeaker;
wherein the apparatus is configured to reduce noise in a space,
said space being predetermined, limited and at a first distance from the noisy system;
wherein the at least one microphone is configured to be positioned at a second distance from the noisy system, and the at least one loudspeaker is configured to be positioned at a third distance from said space; and
wherein the noise processor is configured to generate the acoustic electric signals by processing the noise electric signals so that noise waves coming from the noisy system and the acoustic waves coming from the at least one loudspeaker combine and cancel at said space;
wherein the at least one loudspeaker is positioned at a fourth distance from the at least one microphone, wherein the noise processor is configured so that a processing time of the noise electric signals is smaller than or equal to said fourth distance divided by a sound waves propagation speed in air and a delay time is provided in said apparatus, wherein a sum of said processing time and said delay time is equal to said fourth distance divided by a sound waves propagation speed in air.

2. The apparatus of claim 1,
wherein said second distance is greater than said third distance.

3. The apparatus of claim 1,
wherein said third distance is greater than a third predetermined value.

4. The apparatus of claim 1,
wherein the apparatus comprises a plurality of loudspeakers, in particular arranged as an horizontal array or a vertical array.

5. The apparatus of claim 1, wherein the apparatus configured to be positioned in line with said noisy system and said space.

6. A method for reducing noise generated by a noisy system and propagated through ambient air as noise waves, wherein noise reduction is achieved through an apparatus in a space being predetermined, limited and at a distance from the noisy system, wherein the method comprises the steps carried out by the apparatus of:
b) generating acoustic waves,
c) directing the generated acoustic waves toward the space, and
d) regulating the generated acoustic waves so that so noise waves coming from the noisy system and the generated acoustic waves combine and cancel at said space;
wherein the regulating at step “d” provides introducing a delay time having a value related to said distance and related to positions of said noisy system, of said space, and of components of the apparatus.

7. The method of claim 6, wherein the regulating at step “d” is open-loop type during noise reduction operation.

8. The method of claim 6, wherein at step “b” timing of the generated acoustic waves is regulated.

9. The method of claim 6, wherein at step “b” amplitude of the generated acoustic waves is regulated.

10. The method of claim 6, wherein at step “b” phase of the generated acoustic waves is regulated.

11. The method of claim 6,
wherein the method comprises the step “a” carried out by the apparatus of receiving the noise waves wherein step “a” is performed prior to step “b”, wherein at step “b” the acoustic waves are generated based on the received noise waves,
wherein the regulating at step “d” provides introducing a delay time having a value related to said distance and related to positions of said noisy system, of said space, and of noise waves receiving and acoustic waves generating components of the apparatus.

12. The method of claim 11,
wherein the positions of said noisy system and said space identify a first line segment, wherein the positions of said noisy system and said noise waves receiving component identify a second line segment, wherein the positions of said acoustic waves generating components and said space identify a third line segment,
wherein said delay time is related to lengths of projections of said second line segment and said third line segment on said first line segment.

13. The method of claim 11, wherein the received noise waves are filtered into a plurality of bandwidths and for each bandwidth different acoustic waves are generated.

14. The method of claim 6, wherein at step “b” the acoustic waves are generated based on a preliminary adjustment.

15. The method of claim 14, wherein at step “b” the acoustic waves are generated based on a preliminary training following the preliminary adjustment.

16. The method of claim 6, wherein the steps carried out by the apparatus being positioned in line with said noisy system and said space.

17. The method of claim 6, wherein the steps carried out by the apparatus being divided into first and second identical sections positioned symmetrically with respect to said noisy system and symmetrically with respect to said space.

18. An arrangement comprising a noisy system and an apparatus for reducing noise generated by the noisy system in a space predetermined, limited and at a distance from the noisy system, wherein the apparatus comprises the features set out in claim 1.

19. An arrangement comprising a noisy system and an apparatus for reducing noise generated by the noisy system in a space predetermined, limited and at a distance from the noisy system, wherein the apparatus is configured to implement the method according to claim 6.
